(19) United States
(12) Patent Application Publication
(10) Pub. No.: US 2004/0227094 A1
(43) Pub. Date: Nov. 18, 2004

(54) Microelectronic radiation detector

(76) Inventors: Gary S. Tompa, Belle Mead, NJ (US); Joseph D. Cuchiaro, Colorado Springs, CO (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/774,839

(22) Filed: Feb. 9, 2004

Related U.S. Application Data
(60) Provisional application No. 60/445,861, filed on Feb. 9, 2003.

(51) Int. Cl. G01T 1/24

(52) U.S. Cl. 250/370.01

(57) ABSTRACT

A radiation detector that detects particles using memory cells as the detection medium. A particle strike causes a bit-flip in a memory cell, which is detected by a microprocessor. Advantageously, stacked arrays of memory cells are used to detect the direction of the particle strike. Further, the memory cells may comprise SRAM.

### CROSS REFERENCE TO RELATED APPLICATIONS

This patent application is related to and claims the benefit of Provisional U.S. Patent Application No. 60/445,861, filed Feb. 9, 2003 and is incorporated herein by reference in its entirety. This patent application is also related to U.S. patent application entitled “Smart Portable Detection Apparatus and Method” by Gary Tompa and Joseph Cuchiaro, filed concurrently herewith and incorporated by reference in its entirety.

### FIELD OF THE INVENTION

This invention is related to the field of radiation detectors, and, more specifically, to a microelectronic radiation detector that detects and measures electronic charge due to ionizing activity.

### BACKGROUND OF THE INVENTION

Nuclear threats are an unfortunate and once again growing concern. A very simple dirty bomb can cause billions, if not trillions of dollars in expenses and lost revenues and cause unknown numbers of casualties. Any technology which prevents or mitigates these effects (including preserving the health of the people who go to combat such threats) is invaluable. Further, other common technologies such as nuclear power plants, radiology, etc. require efficient monitoring of radiation to enable swift countering to such threats. One such method to detect such radiation is neutron detection.

The ability quickly and reliably to detect neutron sources at close and long range (>100 m) and obtain their direction of origin has clear applications for nuclear industries, homeland defense and weapons inspection programs. Uranium, plutonium and other neutron-emitting sources that may be used for the manufacture of nuclear or radiological weapons and used in the nuclear industries generate penetrating neutron radiation that can be extremely difficult to conceal by shielding. In fact, attempts at shielding neutron-emitting material (to eliminate its gamma-ray signature, for example) may actually serve to enhance the ability to detect the neutrons by increasing their capture cross-section. As neutrons travel through a medium (lead, steel, concrete, air, etc.) the percentage of thermal to fast neutrons increases. Thermal neutrons deposit more energy per unit path length in the detecting material and are therefore easier to identify.

Neutron detection may thus be the most practical method for identifying certain types of legitimate and illicit radiological materials. It is well known that alpha and beta particles are easily concealed with shielding and are nearly impossible to detect. Gamma radiation, while not as easily shielded as alpha or beta particles can still be fairly difficult to detect because shielding significantly reduces the radiation level and the amount of radiation decreases by a factor of the distance squared, meaning the gamma-ray detector must be at fairly close range (i.e., <10 m). Furthermore, there is a fairly high background level of gamma-radiation at the surface of the earth that can interfere with sensitive measurements. Finally, certain radiological weapons may not generate much gamma radiation in the first place. However, the ability to detect multiple types of radiation is also important.

Neutron detection is more difficult than other radiation detectors that employ charged particle or ionizing photon detection. Because neutrons do not carry a charge, they can not generally be detected directly. The detection generally occurs only after a secondary interaction takes place and a charged particle is generated (such as secondary electron). Traditional approaches to long-range neutron detection have used either moderated or moderator-free detectors. Because such detectors are well know in the art, such detectors are not further discussed. However it should be noted that moderated detectors produce the greatest count rate (because they convert fast neutrons to thermal neutrons for easier detection) but they are heavy and have no directional sensitivity. A moderated neutron detector will have a relatively large mass of absorbing material, such as polyethylene, glass or, most commonly, a sodium iodide crystal, to slow fast neutrons to thermal neutrons and act as the primary means of detection.

Whether moderated or not, most neutron detectors rely on scintillation (i.e., the production of light during neutron interaction). As mentioned, neutrons do not produce ionization directly in materials but can be detected through their interaction with the nuclei of a suitable element. In a ⁶Li-glass scintillation crystal, for example, neutrons interact with ⁶Li nuclei to produce an alpha particle and a triton (tritium nucleus) which in turn produces scintillation light that can be detected. Scintillation detectors can be made relatively small but, in doing so, their sensitivity is greatly degraded. The sensitivity (and therefore response time) of scintillation neutron detectors is directly proportional to their area (when the neutrons are from a know direction) or volume (when the neutron direction is unknown or there is an isotropic distribution of neutrons). Scintillation detectors in general have very little or no directional discernment, they simply measure the magnitude of light generated within the detecting crystal.

Another neutron detector of note that has recently been proposed is based upon Gallium Arsenide (GaAs) technology. GaAs diodes are used to build radiation detectors that are envisioned to be small to compete with “dosimeter” badges. The GaAs chip outputs a pulse for approximately every 13^{th} radioactive particle it encounters. The problem with this design is that the efficiency is 1/13 and with improvement is anticipated to be only 30%.

Thus, there is a need in the art for an inexpensive, versatile radiation detector that is capable of detecting neutron and other ionization effects of radiation.

### SUMMARY OF THE INVENTION

This problem is solved and a technical advance is achieved in the art by a system and method that detects radiation using static, random access memory (SRAM) as the detection medium. It is well known that energetic particles cause single event upsets (SEU's) in microelectronic memories. In fact, designers of spacecraft and satellites go to great lengths and expense to minimize (or even eliminate) SEU's in their electronics. The most well known and highly studied SEU events are in SRAM's, where a single energetic particle will cause an error to become latched into a new state (bit-flip).

In accordance with one aspect of this invention, a radiation detector comprises an array of SRAM's connected to a microprocessor. The microprocessor writes the SRAM array with a predetermined pattern of 1 's and 0's. The microprocessor periodically scans the array for bit-flips. When a bit-flip is detected, the detector has detected an energetic particle, such as those produced by radiation directly (e.g., gamma radiation), or indirectly (e.g., a neutron or other energetic ion produced by a radiation reaction).

Advantageously, the array of SRAM's comprises a three-dimensional array of SRAM's. The microprocessor can then determine direction of origin of the radiation by determining the vector of bit-flips. Further advantageously, the array of SRAM's may be layered on top of the microprocessor, which provides a compact, easy-to-manufacture detection structure that can be used in many applications.

Also advantageously, the array of SRAM's is coated with a material that modifies, enhances or both, the sensitivity, directionality, energy sensitivity, etc. of the detector. The coating may be on a top layer of SRAM or may be on each layer of SRAM. The coating may a hydrogen-rich material and may be a material such as boron-10.

### BRIEF DESCRIPTION OF THE DRAWINGS

A more complete understanding of this invention may be obtained from a study of this specification taken in conjunction with the drawings, in which:

FIG. 1 is a block diagram of a radiation detector in accordance with an exemplary embodiment of this invention;

FIG. 2 is a cross-sectional block diagram of the radiation detector of FIG. 1;

FIG. 3 is a cross-sectional block diagram of a radiation detector in accordance with another aspect of this invention;

FIG. 4 is a perspective view of a ten-layer radiation detector;

FIG. 5 is a block diagram of an SRAM illustrating a single energetic particle causing a bit-flip;

FIG. 6 is a HSPICE simulation of an SRAM cell;

FIG. 7 illustrates a charge collection in a depletion region of the SRAM of FIG. 5;

FIG. 8 is an exemplary interdigitated transistor memory structure in accordance with one aspect of this invention;

FIG. 9 is a graph of detection probability verses distance from source for three exemplary embodiments of this invention;

FIG. 10 is a cross-sectional view of a “weakened” SRAM cell versus a prior art SRAM cell in accordance with an aspect of this invention; and

FIGS. 11A-D are an exemplary construction flow in accordance with a further aspect of this invention.

### DETAILED DESCRIPTION

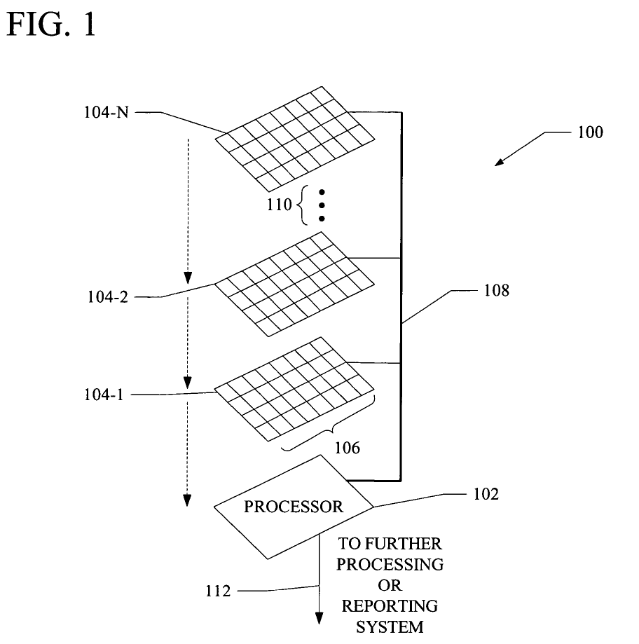

Turning now to FIG. 1, an exploded block diagram of a radiation detector is shown, generally at 100. Radiation detector 100 comprises a processor 102 as a base. A plurality of layers 104 of memory cell arrays 106 is disposed on microprocessor 102 (as represented by dashed arrows). Memory cell arrays 106 are herein illustrated in a row and column array, each box representing one memory cell. This arrangement of memory cells is illustrative; one skilled in the art will be able to maximize information acquisition by using various patterns of memory cells after studying this specification.

In FIG. 1, memory cell arrays 106 layers 104 are illustrated herein as layer 104-1, 104-2 and 104-N. Processor and memory cell arrays 106 layers 104 are illustrated herein as connected via bus 108. Interconnection of memory and processors is well known in the art and therefore not further discussed.

In accordance with an exemplary embodiment of this invention, there may be only one layer 104-1 or two layers 104-1 and 104-2 of memory arrays 106. The more layers (as represented by elision 110) the more accurate the information derived may be. Processor 102 is connected via bus 112 to further processors, reporting systems or both in order to make the information available to the user.

While this invention is described in terms of multiple, stacked structures, one skilled in the art will realize that processor 102 and memory arrays 104 may be on the same chip. Further, this invention is illustrated in the exemplary embodiment of FIG. 1 as stacked memory arrays 104. One skilled in the art will also realize that stacked memory arrays 104 increases directionality wherein parallel memory arrays increase sensitivity.

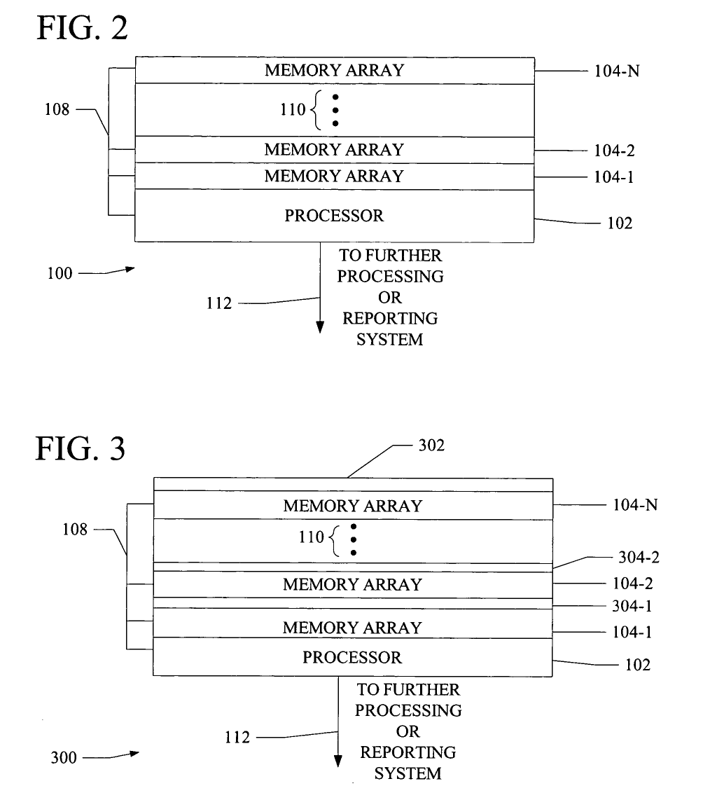

Turning to FIG. 2, a cross-sectional view of a radiation detector 100 in accordance with FIG. 1 is shown. FIG. 2 illustrates that memory arrays 104 are stacked on processor 102. Processor 102 may be arrayed with pins in order to be plugged into a socket for connector 112.

Turning now to FIG. 3, FIG. 3 presents a cross-sectional view of a radiation detector similar to that of FIG. 2. In addition to the structure of FIG. 2, there is a coating 302 on top of memory cell array 104 shown in FIG. 3. Coating 302 may be boron-10, a hydrogen rich compound or other material. These materials react with high energy particles, radiation, or both. This reaction enhances sensitivity, directionality, energy sensitivity, etc., in accordance with the coating's respective properties.

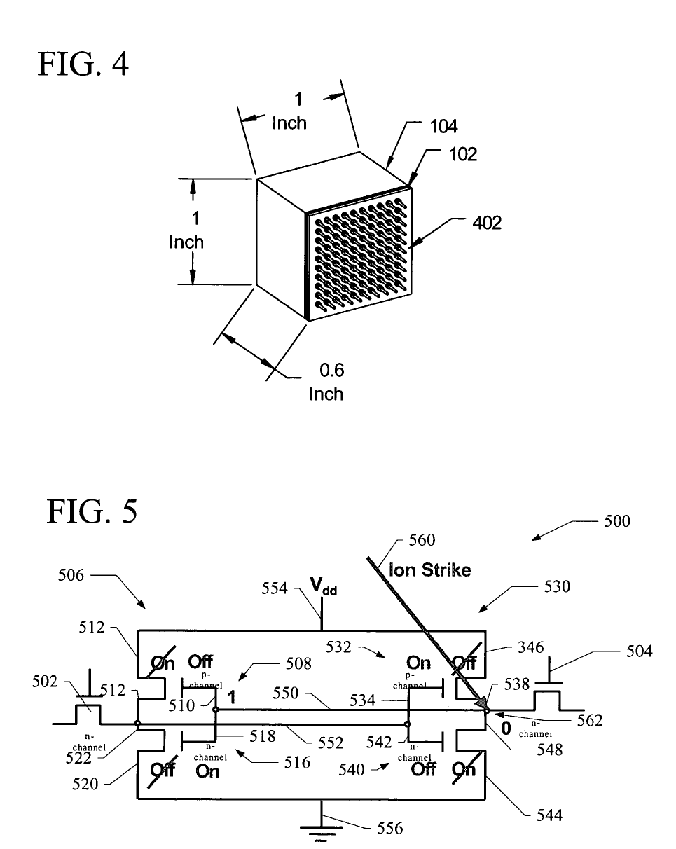

FIG. 4 illustrates a perspective illustration of a radiation detector 100 in accordance with another aspect of this invention. In accordance with this illustrative embodiment, radiation detector 100 comprises 10 layers of memory arrays 104 over microprocessor 102. As illustrated, a radiation detector 100 in accordance with this exemplary embodiment is approximately 1 inch square by 0.6 inch high. Microprocessor 102 includes an array of pins 402 to connect to a socket (not shown, but well known in the art). The illustration of the size of FIG. 4 is merely one aspect of this invention. One skilled in the art will be able to vary the size and shape of a radiation detector in accordance with this invention after studying this specification.

This exemplary embodiment of this invention takes advantage of the well known fact that energetic particles cause single event upsets (SEU's) in microelectronic memories. In fact, designers of spacecraft and satellites go to great lengths and expense to minimize (or even eliminate) SEU's in such electronics. The most well known and highly studied SEU events are in SRAM's, where a single energetic particle will cause an error (bit-flip) to become latched into a new state.

FIG. 5 illustrates a schematic drawing of a 6-transistor, single-bit SRAM cell 500 illustrating how a bit changes state following a particle strike in a sensitive node. There are two gating n-channel transistors 502 and 504 at either end of SRAM 500. Further, a first node 506 of SRAM 500 includes a p-channel transistor 508 comprising a gate 510 source 512 and drain 514, as in known in the art. First node 506 of SRAM 500 also includes an n-channel transistor 516 comprising a gate 518 source 520 and drain 522, as is also known in the art.

A second node 530 of SRAM 500 includes a p-channel transistor 532 comprising gate 534 source 536 and drain 538. Second node 530 also includes a n-channel transistor 540 comprising gate 542 source 544 and drain 548. Gates 510 and 518 are connected together by line 550 connected to gating transistor 504. Likewise, second node 530 transistors gates 534 and 542 are connected via line 552 to gating transistor 502. Voltage is applied at line 554 and ground is at 556.

In FIG. 5, first node 506 is at a “0” prior to a particle strike that generates ions or a charge. A particle, following path 560, strikes at point 562. Following the strike, a charge is generated or deposited at point 562 raising line 550 so that gates 510 and 518 of transistors 508 and 516, respectively, are raised. If the strike generates sufficient charge, then the n-channel 516 transistor turns on and the p-channel transistor 516 turns off, pulling the first node 506 to “0”. If sufficient charge is generated, then the SRAM cell locks in the new “data.” The process continues, with the first node 506 now feeding back to the gates 534 and 542 of n-channel transistor 540 and p-channel transistors 532 on second node 530.

Generally, any atom particle that is either fundamentally charged or creates a charge pulse upon collision with SRAM cell is detected by the exemplary embodiment of this invention. The particle may be an ion, alpha particle, gamma particle, etc. Further, if the particle is a neutron in the above scenario, it strikes an atom, which causes electron-hole pairs, which then creates a charged particle. One skilled in the art will appreciate that a detector in accordance with this invention detects the presence of many types of particles and will be able to apply the principals of this invention to a specific application after studying this specification.

As an example, assume a 4 Mbit SRAM configuration that contains 512K words. Each word is composed of 8 bits with a predetermined pattern of 1's and 0's. For example, assume a word contained an alternating series of 1's and 0's, such that the bit pattern is “10101010”. If an SEU event occurs at least one of the bits is latched into an erroneous state, such that the bit stream may become: “10111010” where the forth bit has been flipped from a 0 to a 1.

Microprocessor 102 continually reads memory 104 and detects the physical location of the bit error. As a particle traversed the multiple SRAM layers, a digital “track” is created allowing the directional angle of the particle to be determined. What makes this approach an almost ideal energetic particle detector is that an extremely small disturbance can become latched into a fully digital state. While a scintillation detector needs an accumulation of dose to generate a sufficient quantity of light to be reliably detected, the SRAM-based microelectronic detector according to this embodiment only needs but a single particle. Select commercial SRAM designs are relatively sensitive. However, sensitivity can be greatly improved by methods in accordance with exemplary embodiment of this invention.

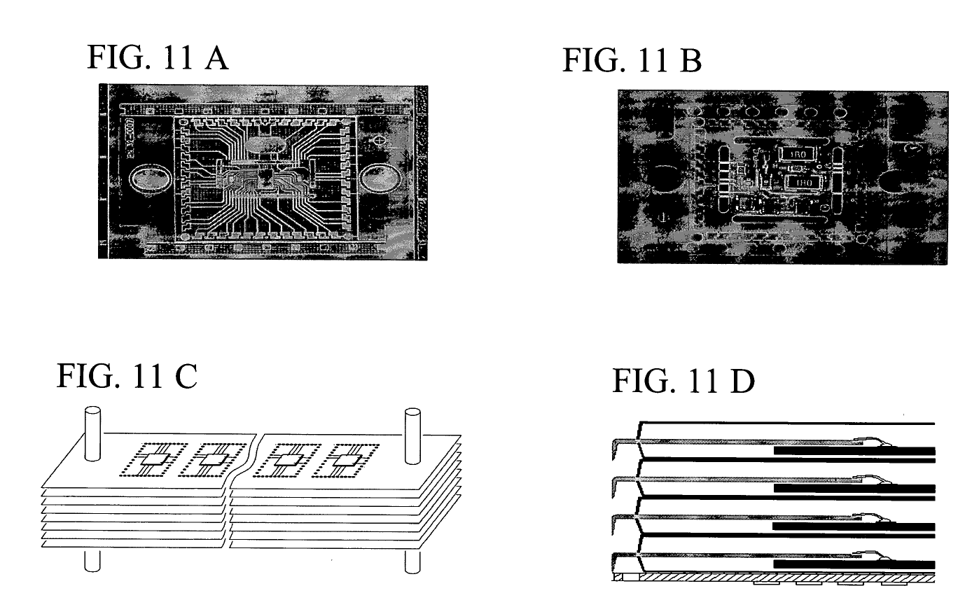

Many commercial memories are sensitive to very low linear energy transfer (LET) particles. To improve the detector's sensitivity, additional SRAM design enhancements can be employed in accordance with an aspect of this invention. As discussed in more detail below, the detector is basically composed of one or many thin layers of SRAM's using a state-of-the-art semiconductor die stacking technology (see FIG. 11). The SRAM's are combined with a microprocessor and formed into a solid cube, in one exemplary embodiment of this invention (FIG. 4). The transistors are weakened to the point that almost any energetic particle will trigger a latch-up state that is simply read by the controller. In accordance with this invention, a detector can be composed of as few as one SRAM array connected to a microprocessor; however, the more SRAM arrays and SRAM layers in the final detector, the more sensitive and better directional response, respectively, can be obtained.

As stated above, neutron detection may be one of the best ways to detect radiation. Unlike gamma ray, alpha and beta particles, however, there are no practical radioisotope sources for neutrons since they are not produced directly by any of the traditional radioactive decay processes. However, there are several methods by which neutrons are be produced; namely in nuclear reactors and processed materials.

Plutonium and uranium (as well as a broad range of other isotopes) decay by alpha particle emission. The alpha particle is absorbed by the nuclei of the low atomic number elements (N, O, F, C, Si, etc.) and a neutron is produced. The neutron yield depends upon the chemical composition of the matrix and the alpha production rate for plutonium and uranium. Neutrons from (α,n) reactions are produced at random and they exhibit a broad energy spectrum which makes shielding very difficult because a percentage of the neutrons have a very high energy. In addition to alpha particle emission and absorption, even-numbered isotopes of plutonium (²³⁸Pu, ²⁴⁰Pu, and ²⁴²Pu) exhibit spontaneous fission (SF) at a rate of 1100, 471, and 800 SF/gram-second respectively. Like (α,n) neutrons, SF neutrons have a broad energy spectrum. SF neutrons are time-correlated (several neutrons are produced at the same time), with the average number of neutrons per fission being between 2.16 and 2.26. Besides the even-numbered isotopes of plutonium, uranium isotopes and odd-numbered plutonium isotopes also spontaneously fission, albeit at a much lower rate (0.0003 to 0.006 SF/gram-second). Table 1 shows the neutron emission rates for various isotopes of plutonium (neutrons/g-sec).

TABLE 1
Spontaneous Fission Neutron Emission of Various Isotopes
of Plutonium

| Isotope | Qn (neutrons/(g-sec) |
|---|---|
| ²³⁶Pu | 3560 |
| ²³⁸Pu | 2660 |
| ²⁴⁰Pu | 920 |
| ²⁴²Pu | 1790 |
| ²⁴⁴Pu | 1870 |

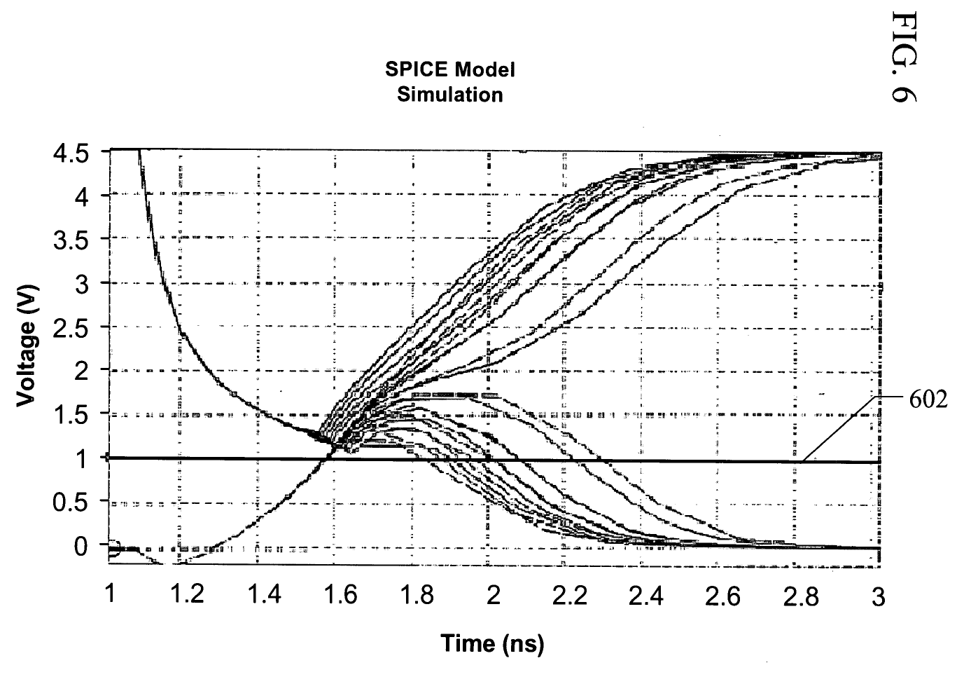

FIG. 6 shows an HSPICE simulation of charge deposited into a sensitive, single-layer SRAM node. In some cases, the charge is insufficient to flip the SRAM cell, i.e., the voltage on the node is pulled down to a little over one volt (dark line 602), but the bit is still able to recover. As progressively larger amounts of charge are introduced into a sensitive node, the bit eventually cannot recover and is locked into the new state.

As discussed above, an SRAM cell may be intrinsically very sensitive to single event upsets, and thus may be suitable as an ultra-sensitive radiation detector without modifications. However, it should be noted that an SRAM cell can be made more sensitive, if necessary, to meet the requirements for long-distance radiation detection. Single event upsets occur when charge deposited in a sensitive node drives the voltage on the node into the opposite state. To improve sensitivity to faster neutrons (lower LET) the drive of the transistors can be minimized, capacitance minimized and any feedback between the two sides of the SRAM minimized. As seen in FIG. 6, a commercial memory cell is often able to recover from a charge-input until some critical charge (Q_{crit}) is met. Q_{crit} can be dramatically lowered (and thus the sensitivity of the detector enhanced) by minimizing the drive of the n- and p-channel transistors. Following a charge strike, the n- or p-channel transistors begin supplying current to offset the charge strike. The stronger the drive of the transistors, the better the recovery. Conversely, the weaker the transistors, the more sensitive the cell. In fact, the drive can be minimized to the point where the cell could be flipped by almost any energetic particle. The simplest method for accomplishing a weak drive state is to maximize the length to width ratio of the transistors.

Minimizing the capacitance of the SRAM cell can further enhance the sensitivity. The voltage swing in response to a charge strike is inversely proportional to the capacitance, i.e., Q=CV where Q is the charge, C is the capacitance and V is the voltage. Therefore, the smaller the capacitance the larger the voltage swing in response to a fixed deposited charge. For detecting neutrons, the larger the voltage swing the more difficult for the cell to correct itself and the more likely we will lock in a bad bit and thus detect the particle.

Finally, the last piece to consider for improving the sensitivity is to minimize feedback between cells. For satellite electronics it is well known that feedback resistors are used to harden SRAM bits to SEU. Minimizing feedback increases the difficulty for the cell to correct itself, and thus increases the sensitivity of the detector.

In addition to making the cell more sensitive, it is also advantageous to maximize the capture cross section. Based on the above discussion, it is clear that a microelectronic radiation detector may be very sensitive; however, an ion can only be detected if it strikes a sensitive node. The charge is actually captured in the depletion region between the source or drain diffusion and the well or substrate.

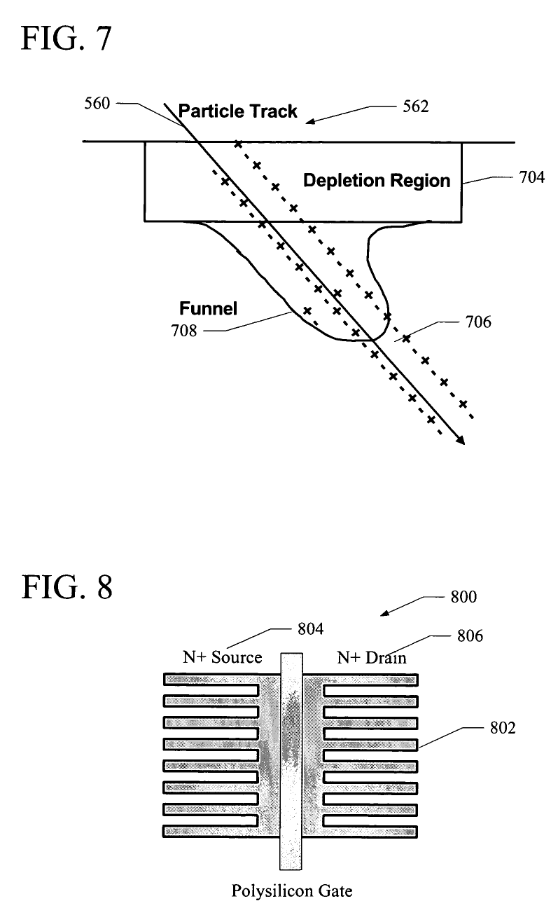

FIG. 7 illustrates a conceptual drawing of how a charge is captured during a particle strike. Maximizing the capture cross-section, then, is simply a matter of maximizing the depletion region cross-section. FIG. 7 illustrates charge collection 702 in a depletion region 704. Note that the particle 560 creates a dense track of electron hole pairs 706, thus ionizing the atoms. The electron hole pairs are only collected where there is an internal electric field, as exists in the depletion region 704 and funnel region 708, which is actually created by the particle itself.

The most straightforward method to increase sensitivity is to use an interdigitated or a combed structure with the constraint that the drive of the transistors is not increased (otherwise sensitivity is degraded). FIG. 8 shows an example of an interdigitated type structure 800.

In the particular example of FIG. 8, a depletion region 802 (dark line around structure) is greatly increased without increasing the drive of the individual transistors. Note that depletion region 802 is formed along the entire perimeter of source 804 and drain 806. This type of structure has a much greater perimeter than a typical rectangular source and drain structure.

The following discussion demonstrates the actual feasibility of this invention to detect neutrons from radiological materials. Based on current single event radiation effects data acquired by JPL, NASA, the Aerospace Corporation and radiation hardened component manufactures, the saturated error cross-section for a “soft” 4 Mbit commercial SRAM is approximately 2.5E-7 errors/cm²-bit or 1 error/cm² per device (each device is approximately 1.7 cm² in area). Therefore the capture efficiency of an SRAM device is approximately 70%, which is about the percentage of the memory array of the chip (the remainder of the chip is support logic and input/output cells). In a first order estimate, assume that the memory cell itself is 100% effective. The reason the memory array is so efficient is that the SRAM cells are very tightly packed (there are 4,096,000 cells packed into 1 cm² or 1 cell/2E-7 cm² (1 cell/20 μm²) and each cell has as many as 6 sensitive nodes). Therefore the average separation distance between sensitive nodes is 1 node/3.3 μm² (this is actually a worst case example since we are assuming that the node is a point; in reality a node covers a sizable portion of each cell). The ionizing track diameter is estimated to be up to 5 μm in diameter. Obviously the probability that a 5 μm track can penetrate a 3.3 μm separation distance without detection is quite small. However this is yet again a worst case example since we are assuming only 2-dimensions, the junctions also have depth. Even if an ion track somehow misses the top part of the junction, there is still several microns of depletion region depth to collect the charge). This simplified argument helps to explain (and hopefully provides a “sanity check”) how the detection probability approaches 100%.

Further, the addition of a coating of boron-10 or hydrogen rich material onto the SRAM in accordance with another aspect of this invention improves radiation detection. A high-energy neutron, when it hits a proton in hydrogen rich material, generates an ionization track. A low energy neutron may be captured by boron-10, which then emits an alpha particle. This reaction also generates an ionization trail. Additionally, a detector in accordance with this invention also detects unshielded alpha and gamma radiation.

For the following example the neutron production rates from two sources of plutonium, ²³⁶Pu and ²⁴⁰Pu are used (²³⁶Pu used has the highest neutron production rate and ²⁴⁰Pu has the lowest, of course any weapons grade material will have a combination of all the various isotopes of Pu listed in Table 1), but ²³⁶Pu can be considered a favorable example and ²⁴⁰Pu can be assumed to be a worst case example. Table 2 lists the neutrons/m² at various distances from the source (assuming 1 kg of material) for the two different isotopes mentioned above.

TABLE 2

| Distance from | Surface | Neutrons/cm2-sec | Neutrons/cm2-sec |
|---|---|---|---|
| Source(m) | Area (m2) | (from 1 kg 240Pu) | (from 1 kg 236Pu) |
| 0.01 | 0.001256637 | 732112.7382 | 2832957.987 |
| 0.02 | 0.005026548 | 183028.1846 | 708239.4968 |
| 0.05 | 0.031415927 | 29284.50953 | 113318.3195 |
| 0.1 | 0.125663706 | 7321.127382 | 28329.57987 |
| 0.2 | 0.502654825 | 1830.281846 | 7082.394968 |
| 1 | 12.56637061 | 73.21127382 | 283.2957987 |
| 2 | 50.26548246 | 18.30281846 | 70.82394968 |
| 5 | 314.1592654 | 2.928450953 | 11.33183195 |
| 10 | 1256.637061 | 0.732112738 | 2.832957987 |
| 50 | 31415.92654 | 0.02928451 | 0.113318319 |
| 100 | 125663.7061 | 0.007321127 | 0.02832958 |
| 200 | 502654.8246 | 0.001830282 | 0.007082395 |
| 500 | 3141592.654 | 0.000292845 | 0.001133183 |
| 1000 | 12566370.61 | 7.32113E−05 | 0.000283296 |

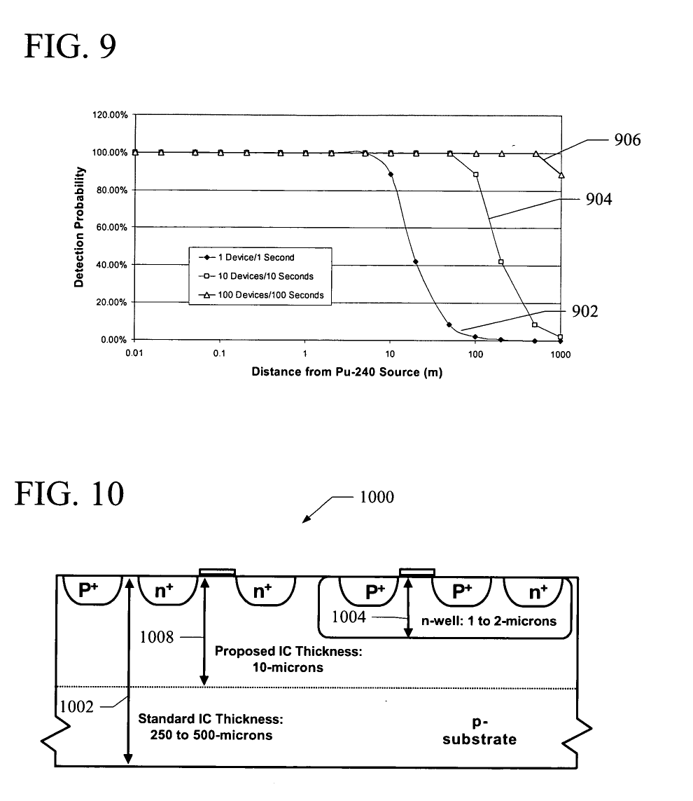

A simple binomial analysis is used to determine the first order probability of detection based on the capture cross-section of the SRAM die and the number of neutrons/cm²-s at various distances from the neutron source. For this example, assume a capture efficiency of 95% of the SRAM cells. FIG. 9 shows a plot of detection probability versus distance from the source for the lowest neutron generating material (²⁴⁰Pu) using three different scenarios, (i) A single detector with only 1 second of collection time 902, (ii) 10 detectors with 10 seconds of collection time 904 and finally (iii) 100 detectors with 100 seconds of collection time 906. Note that a single device will reliable detect a neutron source out to about 10 meter in 1 second, 10 devices will reliable detect the neutron source in 10 seconds out to 100 meters. One hundred detectors, if allowed 100 seconds of accumulation time, can reliably detect a neutron source from about 1 km.

The final piece necessary for the manufacture of the microelectronic radiation detector is packaging. To give the highest radiation capture cross-section in 3-dimensions the SRAM detector bits should be packed as tightly as possible, not only in the x and y dimensions, but also in the z direction. Turning now to FIG. 10. a comparison is shown, generally at 1000, between a typical integrated circuit (IC) thickness and an IC in accordance with an exemplary embodiment of this invention. Typically, a semiconductor IC is left at 250 to 500 μm in thickness 1002. The active area of a 0.25 μm process is only 3 to 5 μm 1004, so thinning the die to 10 μm 1008 does not affect device performance or reliability but increases the packing density needed for this ultra-sensitive detector.

Once the silicon is properly thinned the IC can be mounted on a lead frame, each individual mounted die can then be stacked and molded into a solid cube. FIGS. 11A-D illustrate the proposed flow for fabricating the cube detector. FIG. 11A shows what the proposed lead frame would look like and FIG. 11B shows the die mounted on the lead frame. FIG. 11C shows multiple lead-frames stacked together and FIG. 11D shows a cross section of the cube after the molding process. The proposed molding process could use a Dexter Hysol semiconductor-grade epoxy to form the cube, encapsulate and protect the integrated circuits. Electrical connection will be made to the sides of the cube through a nickel/gold plating process. The electrical routing can take place along the side of the cube to a lead frame on the bottom of the cube.

The convenient microelectronic nature of our device allows for both fixed position deployment as well as highly portable hand held probes that can easily be wirelessly integrated into a full monitoring array or kept as a stand-alone dosimeter.

It is understood that the above-described embodiment is merely illustrative of the present invention and that many variations of the above-described embodiment can be devised by one skilled in the art without departing from the scope of this invention. For example, the softening of the device to radiation can also be applied to non-SRAM devices, other transistor-based devices, diode-based device, or both. One skilled in the art should readily understand how to apply the above-described modifications to many devices (e.g., Flash, EPROM, PROM, etc.) after studying this specification. Further, one skilled in the art should readily understand how to sensitize a layer to a different radiation indicator (e.g., alpha radiation, gamma radiation, neutrons, etc.) after studying this specification. Additionally, one skilled in the art should readily understand how to sensitize a layer to a different radiation indicator by applying a different coating material to each layer. It is therefore intended that such variations be included within the scope of the following claims and their equivalents.

What is claimed is:

1. A radiation detector comprising:
an array of memory cells;
a processor connected to said memory cells and configured to detect a bit flip in one or more of said memory cells.

2. A radiation detector in accordance with claim 1 wherein said array of memory cells comprises an array of static, random access memory cells (SRAM).

3. A radiation detector in accordance with claim 1 wherein said array of memory cells comprises a two-dimensional array.

4. A radiation detector in accordance with claim 3 further including a plurality of arrays of memory cells.

5. A radiation detector in accordance with claim 3 further including a stacked plurality of memory cells.

6. A radiation detector in accordance with claim 5 wherein said stacked plurality of memory cells comprises two stacked arrays of memory cells.

7. A radiation detector in accordance with claim 5 wherein said stacked plurality of memory cells comprises ten stacked arrays of memory cells.

8. A radiation detector in accordance with claim 1 wherein said processor is configured to detect a bit flip by
writing a predetermined pattern of 1's and 0's in said memory array; and
determining a wrong bit in said predetermined pattern.

9. A radiation detector in accordance with claim 1 wherein said array of memory cells comprises a stacked plurality of memory cells and wherein said processor is configured to further detect a direction of an ion by determining a plurality of wrong bits in said stacked plurality of memory cells.

10. A radiation detector in accordance with claim 1 wherein said radiation detector is approximately less than one cubic inch.

11. A radiation detector in accordance with claim 1 wherein said memory cells are softened to improve susceptibility to ions causing bit flips.

12. A radiation detector in accordance with claim 1 wherein said memory cells are coated with a material that reacts with radiation to generate ionization.

13. A method of detecting radiation for use in a structure comprising a processor and a plurality of layers of memory cell arrays, said method comprising:
distributing a predetermined pattern of 1 's and 0's in said memory cell arrays; and
detecting a particle strike by scanning said memory cell array for a bit flip.

14. A method in accordance with claim 13 further comprising:
periodically scanning said memory cell array for one or more bit flips.

15. A method in accordance with claim 13 further comprising:
restoring said predetermined pattern after detecting a particle strike.

16. A method in accordance with claim 13 further comprising:
determining an angle of incidence of said particle strike from a pattern of bit flips in said plurality of layers caused by said particle strike.

17. A method in accordance with claim 16 wherein determining an angle of incidence comprises analyzing bit flips on each layer of memory cells.

18. A radiation detector comprising:
a microelectronic detection circuit configured to change state in response to radiation; and
a microprocessor connected to said detection circuit responsive to changes in state of said detection circuit configured to report detection.

19. A radiation detector in accordance with claim 18 wherein said microelectronic detection circuit is further configured to detect secondary interactions caused by radiation.

20. A radiation detector in accordance with claim 18 wherein said microelectronic detection circuit is coated with a material to enhance detection of radiation.

21. A radiation detector in accordance with claim 18 wherein said microelectronic detection circuit comprises stacked arrays of detector circuits.

22. A radiation detector in accordance with claim 21 wherein each of said stacked arrays of detector circuits is coated with a material to enhance detection of radiation.

23. A radiation detector in accordance with claim 21 wherein each of said stacked arrays of detector circuits is sensitized to a particular radiation indicator.

24. A radiation detector in accordance with claim 18 wherein said microelectronic detection circuit is selected from a group comprising SRAM, DRAM, EEPROM and diodes.
